(19) United States
(12) Patent Application Publication
(10) Pub. No.: US 2007/0240278 A1
(43) Pub. Date: Oct. 18, 2007

(54) Automatic cleaning system

(76) Inventor: Willard S. MacDonald, Bolinas, CA (US)

Correspondence Address: Willard S. MacDonald, 825 Olema-Bolinas Rd., Bolinas, CA, 94924, US

(21) Appl. No.: 11/786,674

(22) Filed: Apr. 12, 2007

Related U.S. Application Data
(60) Provisional application No. 60/792,303, filed on Apr. 14, 2006.

(51) Int. Cl. B08B 3/00

(52) U.S. Cl. 15/405; 134/56 R; 15/316.1

(57) ABSTRACT

An automatic cleaning system includes a pressure tank and a pressurizer thermally coupled to the pressure tank that increases the pressure of air within the pressure tank based on transferring heat from absorbed solar energy to the air within the pressure tank. A release valve coupled to a jet directs expelled air based on a positive differential between an internal pressure of the pressure tank and an ambient pressure of an ambient environment.

### CROSS-REFERENCE TO RELATED APPLICATIONS

Pursuant to 35 U.S.C. 119(e), this application for patent claims priority to the filing date of U.S. Provisional Patent Application Ser. No. 60/792,303 filed on Apr. 14, 2006; the disclosure of which is herein incorporated by reference.

### BACKGROUND OF THE INVENTION

Solar panels typically have a glass top that provides protection against weather and foreign objects. The glass top enables sunlight to pass through to solar energy collectors that are positioned within the solar panels below the glass top. However accumulation of dirt, pollen, dust, ash, leaves, pine needles, twigs, or other particles on the glass top can reduce the amount of sunlight that passes through to the solar energy collectors, which can reduce the efficiency of the solar panels.

Manual cleaning methods, such as rinsing the glass top with water or scrubbing the glass top with a cloth, are typically used to remove these particles from the glass top to limit reductions in efficiency of the solar panel. However, manual cleaning may be inconvenient or difficult to perform because solar panels may be positioned on roof tops or other locations that are difficult to access. Manual cleaning also relies on a person being present to perform the manual cleaning, which may limit the frequency with which the solar panels are cleaned.

### SUMMARY OF THE INVENTION

An automatic cleaning system according to embodiments of the present invention provides expelled air that can be directed over the glass top of a solar panel by a jet. The expelled air, as directed by the jet, is suitable for displacing particles from the glass top, which enables the automatic cleaning system to be used instead of manual cleaning or in conjunction with manual cleaning.

### BRIEF DESCRIPTION OF THE DRAWINGS

The present invention can be better understood with reference to the following figures. The components in the figures are not necessarily to scale. Emphasis is instead placed upon illustrating the principles and elements of the present invention.

FIG. 1 shows an example of an automatic cleaning system according to a first embodiment of the present invention.

FIG. 2 shows an example of an automatic cleaning system according to a second embodiment of the present invention.

FIG. 3 shows an example of an automatic cleaning system according to a third embodiment of the present invention.

FIG. 4 shows an example of the automatic cleaning system, according to embodiments of the present invention, configured with a solar panel.

FIGS. 5A-5D show examples of pressurizers and pressure tanks suitable for inclusion in the automatic cleaning systems according to the embodiments of the present invention.

FIG. 5E shows an example of a pressurizer, pressure tank, and pressure amplifier suitable for inclusion in the automatic cleaning systems according to the embodiments of the present invention.

FIGS. 6A-6C show examples of release valves suitable for inclusion in the automatic cleaning systems according to the embodiments of the present invention.

### DETAILED DESCRIPTION OF THE INVENTION

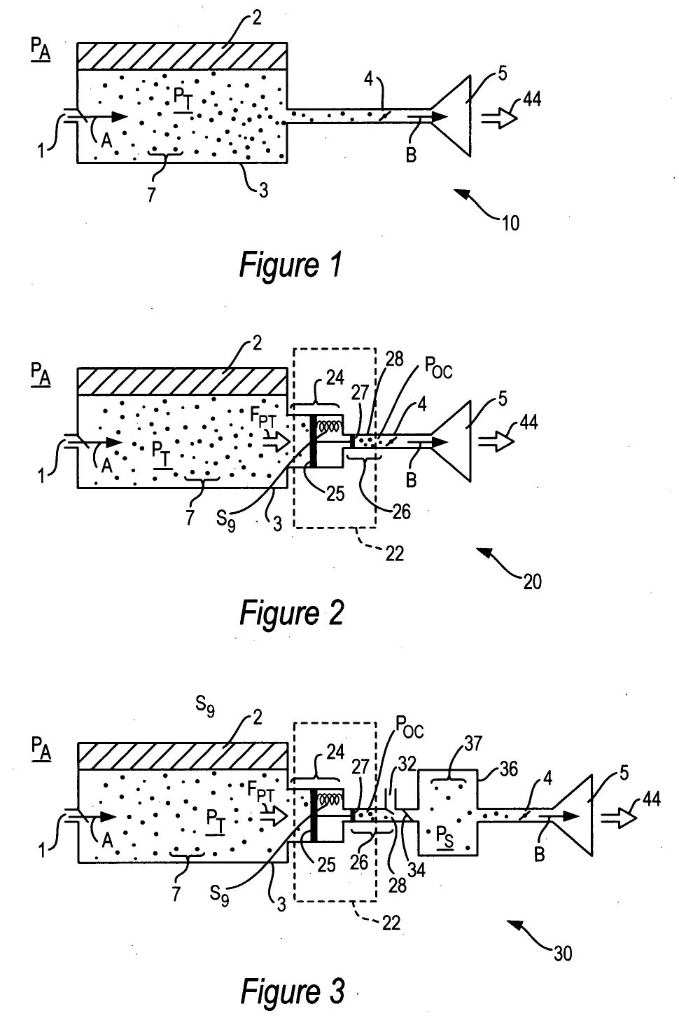

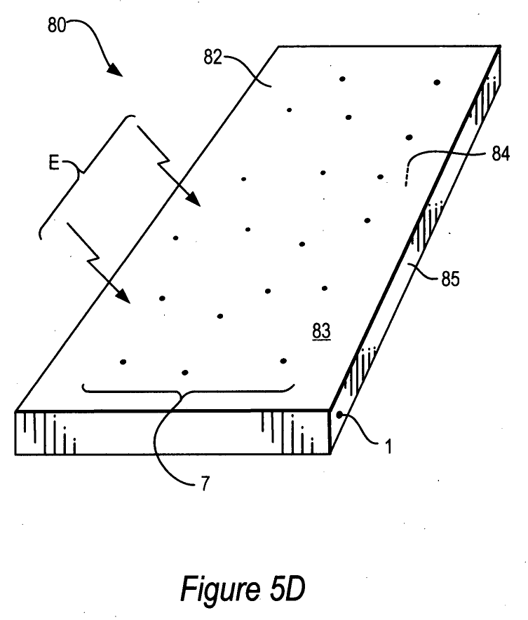

FIGS. 1-3 show examples of automatic cleaning systems 10, 20, 30 according to alternative embodiments of the present invention. Each of the automatic cleaning systems 10, 20, 30 includes a pressurizer 2, a pressure tank 3, a release valve 4, and a jet 5 coupled to the release valve 4. The pressurizer 2 increases the pressure of air 7 contained within the pressure tank 3, which enables air 44 to be expelled through the jet 5 to clean a solar panel 6, as shown in FIG. 4.

FIG. 1 shows an example of an automatic cleaning system 10 according to a first embodiment of the present invention. The pressure tank 3 of the automatic cleaning system 10 has an intake valve 1 that enables air to be drawn from an ambient environment into the pressure tank 3 in the direction of arrow A. This ambient air is drawn through the intake valve 1 and into the pressure tank 3 in response to a negative differential between the internal pressure P_{T} of the pressure tank 3 and the ambient pressure P_{A} of the ambient environment. The intake valve 1 typically includes a check valve or other type of unidirectional valve that enables air to flow in the direction of the arrow A, while preventing air from flowing out of the pressure tank 3 in a direction opposite to that of the arrow A. The intake valve 1 alternatively includes a switch valve that can be configured in an open state or a closed state. In the open state, the switch valve provides a port for an exchange of air between the pressure tank 3 and the ambient environment, which enables the internal pressure P_{T} of the pressure tank 3 to be equalized with the ambient pressure P_{A} of the ambient environment. In the closed state, the switch valve prevents air from flowing out of the pressure tank 3 in a direction opposite to that of the arrow A. Preventing air 7 from flowing out of the pressure tank 3 enables the pressurizer 2 to increase the internal pressure P_{T} of the pressure tank 3.

The release valve 4 enables air 7 contained within the pressure tank 3 to be expelled from the pressure tank 3 in the direction of arrow B, once the pressurizer 2 increases the internal pressure P_{T} of the pressure tank 3. This air is expelled through the release valve 4 in response to a positive differential between the internal pressure P_{T} of the pressure tank 3 and the ambient pressure P_{A} of the ambient environment. The release valve 4 is typically actuated based on the internal pressure P_{T} of the air 7 contained within the pressure tank 3, or according to time, temperature, or other designated parameters. Alternatively, the release valve 4 is manually actuated. Actuating the release valve 4 provides an open port to expel pressurized air from the pressure tank 3 through the jet 5. Closing the release valve 4 prevents the air contained within the pressure tank 3 from flowing out of the pressure tank 3. Preventing air from flowing out of the pressure tank 3 enables the pressurizer 2 to increase the internal pressure P_{T} of the pressure tank 3.

The pressure tank 3 provides a chamber for containing the air that is drawn into the pressure tank 3 in the direction A through the intake valve 1, until the air 7 is expelled in the direction B through the release valve 4 and through the jet 5. According to alternative embodiments of the automatic cleaning system 10, the intake valve 1 and the release valve 4 are integrated or otherwise combined into a single valve. The single valve provides a port for air to be drawn into the pressure tank 3 in response to a negative differential between the internal pressure P_{T} of the pressure tank 3 and the ambient pressure, prevents air from flowing out of the pressure tank 3 to enable the pressurizer 2 to increase the internal pressure P_{T} of the pressure tank 3, and provides for the expelling of air 7 from the pressure tank 3 through the jet 5.

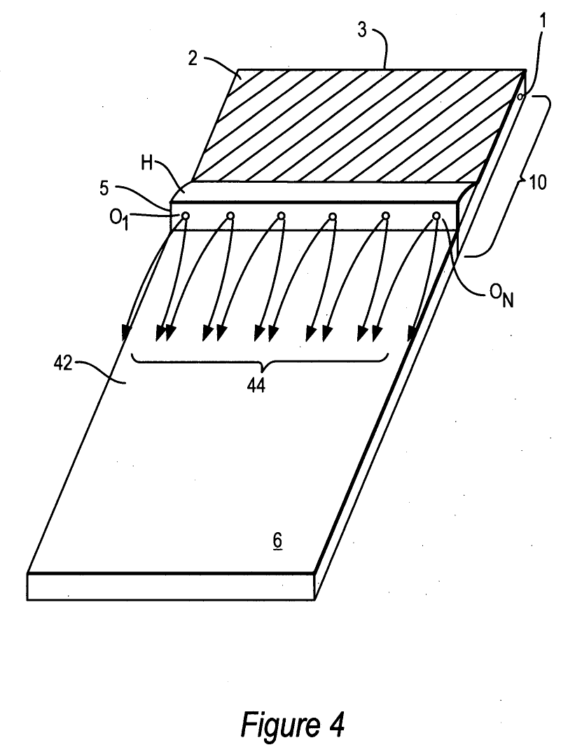

FIG. 2 shows an example of an automatic cleaning system 20 according to a second embodiment of the present invention. The automatic cleaning system 20 includes a pressure amplifier 22 coupled between the pressure tank 3 and the release valve 4. As in the automatic cleaning system 10 shown in FIG. 1, the pressure tank 3 of the automatic cleaning system 20 has an intake valve 1 that enables air to be drawn from an ambient environment into the pressure tank 3 in the direction of arrow A. This ambient air is drawn through the intake valve 1 and into the pressure tank 3 in response to a negative differential between the internal pressure P_{T} of the pressure tank 3 and the ambient pressure P_{A} of the ambient environment. The intake valve 1 typically includes a check valve or other type of unidirectional valve that enables air to flow in the direction of the arrow A, while preventing air 7 from flowing out of the pressure tank 3 in a direction opposite to that of the arrow A. The intake valve 1 alternatively includes a switch valve that can be configured in an open state or a closed state. In the open state, the switch valve provides a port for an exchange of air between the pressure tank 3 and the ambient environment, which enables the internal pressure P_{T} of the pressure tank 3 to be equalized with the ambient pressure P_{A} of the ambient environment. In the closed state, the switch valve prevents air 7 from flowing out of the pressure tank 3 in a direction opposite to that of the arrow A. Preventing air 7 from flowing out of the pressure tank 3 enables the pressurizer 2 to increase the internal pressure P_{T} of the pressure tank 3.

In the example shown in FIG. 2, the pressure amplifier 22 includes an input cylinder 24 and an input piston 25 that are exposed to the air 7 within the pressure tank 3, which exposes the air 7 to the input piston 25. The input piston 25 makes a seal with internal wall of the input cylinder 24. The input piston 25 is displaced within the input cylinder 24 in response to a force F_{PT} exerted by the air 7 contained within the pressure tank 3. The pressure amplifier 22 also includes an output cylinder 26 and an output piston 27 that have smaller cross-sectional area than the input cylinder 24 and input piston 25. The output piston 27 makes a seal with internal wall of the output cylinder 26. The output piston 27 is sufficiently connected to the input piston 25 to enable displacements of the input piston 25 within the input cylinder 24 to provide corresponding displacements of the output piston 27 within the output cylinder 26. The smaller cross-sectional area of the output piston 27 and the output cylinder 26 relative to the larger cross-sectional area of the input piston 25 and the input cylinder 24 cause the output piston 27 to amplify increases that occur in the internal pressure P_{T} of the pressure tank 3 and increases in the force F_{PT} provided to the input piston 25. This causes increases in the internal pressure P_{T} of the pressure tank 3 to result in amplified increases in the pressure P_{OC} of the air 28 within the output cylinder 26. While the input cylinder 24, input piston 25, output cylinder 26 and output piston 27 typically have a circular cross-section, these elements can have any other suitable cross-sectional shape.

The release valve 4 enables the air 28 within the output cylinder 26, as compressed by the output piston 27, to be expelled from the output cylinder 26 in the direction of arrow B, once the pressurizer 2 increases the internal pressure P_{T} of the pressure tank 3 and the pressure amplifier 22 amplifies this pressure increase in the output cylinder 26. The air 28 contained within the output cylinder 26 is expelled through the release valve 4 in response to a positive differential between the internal pressure P_{OC} of the output cylinder 26 and the ambient pressure P_{A} of the ambient environment. The release valve 4 is typically actuated based on the pressure P_{T} of the air 7 contained within the pressure tank 3, the pressure P_{OC} of the air 28 contained in the output cylinder 26, or according to time, temperature, or other designated parameters. Alternatively, the release valve 4 is manually actuated. Actuating the release valve 4 provides an open port to expel pressurized air 28 from the output cylinder 26 through the jet 5. Closing the release valve 4 prevents the air 28 contained within the output cylinder 26 from flowing out of the output cylinder 26. Preventing air 28 from flowing out of the output cylinder 26 enables the pressurizer 2 to increase the pressure of the air 7 contained within the pressure tank 3. This enables the pressure amplifier 22 to increase the pressure P_{OC} of the air 28 contained within the output cylinder 26 until air is expelled from the output cylinder 26 in the direction B through the release valve 4 and through the jet 5.

To accommodate operating cycles of the automatic cleaning system 20, the pressure amplifier 22 in the example shown in FIG. 2 includes a spring S₉ to restore the position of the input piston 25 and the output piston 27 of the pressure amplifier 22 once the air is expelled from the output cylinder 26. In this example, the release valve 4 provides for air to be drawn in a direction opposite to that of arrow B to enable the spring S₉ to restore the position of the piston 25 and the piston 27. As an alternative to the release valve 4 providing for the air to be drawn in the direction opposite to that of the arrow B, a check valve (not shown) can be coupled to the output piston 26 to enable air to be drawn into the output cylinder 26 to enable the spring S₉ to restore the position of the input piston 25 and the output piston 27 once the air is expelled from the output cylinder 26. In an alternative example, the intake valve 1 is omitted from the pressure tank 3 and the spring S₉ is omitted from pressure amplifier 22. In this example, the release valve 4 provides for air to be drawn in a direction opposite to that of arrow B to enable the position of the input piston 25 and the output piston 27 to be restored in response to a negative differential between the internal pressure P_{T} of the pressure tank 3 and ambient pressure P_{A} of the ambient environment. As an alternative to the release valve 4 providing for the air to be drawn in the direction opposite to that of the arrow B, a check valve (not shown) is coupled to the output piston 26 to provide air to be drawn into the output cylinder 26 to enable the position of the input piston 25 and the output piston 27 to be restored once the air 28 is expelled from the output cylinder 26.

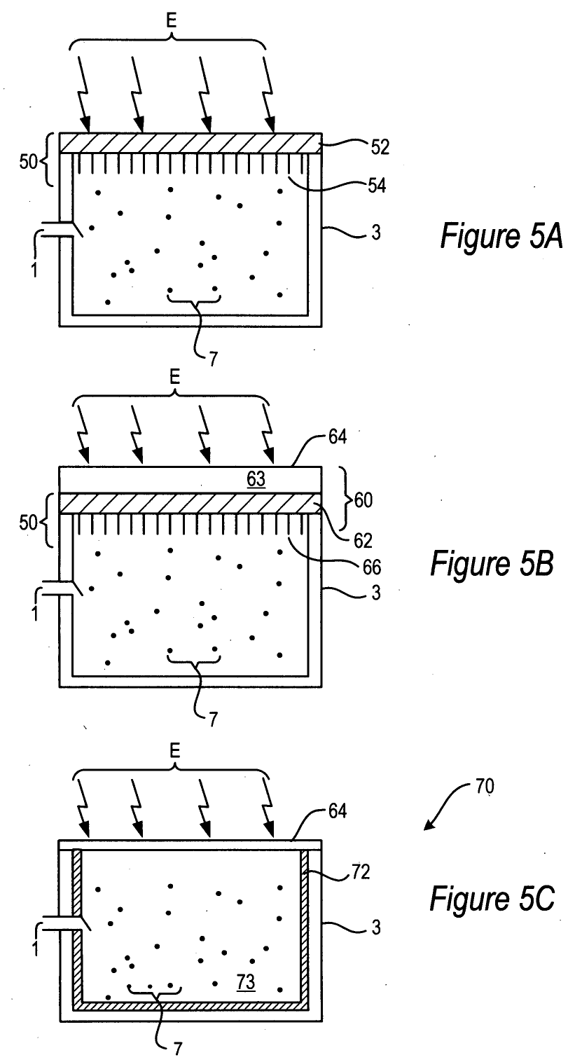

FIG. 3 shows an example of an automatic cleaning system 30 according to a third embodiment of the present invention. In addition to the elements included in the automatic cleaning system 20 shown in FIG. 2, the automatic cleaning system 30 of FIG. 3 includes an input check valve 32, an output check valve 34, and a storage tank 36 coupled between the pressure amplifier 22 and the release valve 4. As in the automatic cleaning systems 10, 20, shown in FIG. 1 and FIG. 2, respectively, the pressure tank 3 of the automatic cleaning system 30 has an intake valve 1 that enables air to be drawn from an ambient environment into the pressure tank 3 in the direction of arrow A. This ambient air is drawn through the intake valve 1 and into the pressure tank 3 in response to a negative differential between the internal pressure P_{T} of the pressure tank 3 and the ambient pressure P_{A} of the ambient environment. The intake valve 1 typically includes a check valve or other type of unidirectional valve that enables air to flow in the direction of the arrow A, while preventing air 7 from flowing out of the pressure tank 3 in a direction opposite to that of the arrow A. The intake valve 1 alternatively includes a switch valve that can be configured in an open state or a closed state. In the open state, the switch valve provides a port for an exchange of air between the pressure tank 3 and the ambient environment, which enables the internal pressure P_{T} of the pressure tank 3 to be equalized with the ambient pressure P_{A} of the ambient environment. In the closed state, the switch valve prevents air 7 from flowing out of the pressure tank 3 in a direction opposite to that of the arrow A. Preventing air 7 from flowing out of the pressure tank 3 enables the pressurizer 2 to increase the internal pressure P_{T} of the pressure tank 3.

As in the automatic cleaning system 20 shown in FIG. 2, the pressure amplifier 22 in the automatic cleaning system 30 shown in FIG. 3 includes an input cylinder 24 and an input piston 25 that are exposed to the air 7 within the pressure tank 3, which exposes the pressure of the air 7 to the input piston 25. The input piston 25 makes a seal with internal wall of the input cylinder 24. The input piston 25 is displaced within the input cylinder 24 in response to a force F_{PT} exerted by the air 7 contained within the pressure tank 3. The pressure amplifier 22 also includes an output cylinder 26 and an output piston 27 that have smaller cross-sectional area than the input cylinder 24 and input piston 25. The output piston 27 makes a seal with internal wall of the output cylinder 26. The output piston 27 is sufficiently connected to the input piston 25 to enable displacements of the input piston 25 within the input cylinder 24 to provide corresponding displacements of the output piston 27 within the output cylinder 26. The smaller cross-sectional area of the output piston 27 and the output cylinder 26 relative to the larger cross-sectional area of the input piston 25 and the input cylinder 24 cause the output piston 27 to amplify increases that occur in the internal pressure P_{T} of the pressure tank 3 and increases in the force F_{PT} provided to the input piston 25. This causes increases in the internal pressure P_{T} of the pressure tank 3 to result in amplified increases in the pressure P_{OC} of the air within the output cylinder 26.

The storage tank 36 is coupled to the output cylinder 26 of the pressure amplifier 22 through the output check valve 34 to enable the output cylinder 26 to transfer pressure increases that occur in the output cylinder 26 to the storage tank 36. The output check valve 34 and the pressure amplifier 22 function as a pump that pressurizes the air 37 contained within the storage tank 36 to increase the internal pressure P_{S} of the storage tank 36. The input check valve 32 provides a unidirectional valve that enables air to be drawn into the output cylinder 26 in response to a negative differential between the pressure P_{OC} of the air 28 within the output cylinder 26 and the ambient pressure P_{A} of the ambient environment. The input check valve 32 also enables air to be drawn into the storage tank 36 in response to a negative differential between the pressure P_{S} of the air 37 within the storage tank 36 and the ambient pressure P_{A} of the ambient environment.

The release valve 4 enables the air 37 that is contained within the storage tank 36 to be expelled from the storage tank 36 in the direction of arrow B, once the pressurizer 2 increases the internal pressure P_{T} of the pressure tank 3 and once the pressure amplifier 22 amplifies this pressure increase and transfers the amplified pressure increases to the storage tank 36. The air 37 contained within the storage tank 36 is expelled through the release valve 4 in response to a positive differential between the internal pressure P_{S} of the storage tank 36 and the ambient pressure P_{A} of the ambient environment. The release valve 4 is typically actuated based on the pressure P_{S} of the air 37 contained within the storage tank 36, or according to time, temperature, or other designated parameters. Alternatively, the release valve 4 is manually actuated. Actuating the release valve 4 provides an open port to expel pressurized air 37 from the storage tank 36 through the jet 5. Closing the release valve 4 prevents the air 37 contained within the storage tank 36 from flowing out of the storage tank 36. Preventing air from flowing out of the storage tank 36 enables the pressurizer 2 to increase the pressure P_{T} of the air 7 contained within the pressure tank 3, which enables the pressure amplifier 22 to increase the pressure P_{S} of the air 37 contained within the storage tank 36, until the air 37 is expelled from the storage tank 36 in the direction B through the release valve 4 and through the jet 5.

To accommodate operating cycles of the automatic cleaning system 30, the pressure amplifier 22 in the example shown in FIG. 3 also includes a spring S₉ to restore the position of the input piston 25 and the output piston 27 of the pressure amplifier 22 once the air 37 is expelled from the storage tank 36. In this example, the input check valve 32 provides for air to be drawn into the output cylinder 26 to enable the spring S₉ to restore the position of the input piston 25 and the output piston 27. In an alternative example, the intake valve 1 is omitted from the pressure tank 3 and the spring S₉ is omitted from pressure amplifier 22. In this example, the input check valve 32 provides for air to be drawn into the output cylinder 26 to enable the position of the piston 25 and the piston 27 to be restored in response to a negative differential between the internal pressure P_{T} of the pressure tank 3 and ambient pressure P_{A} of the ambient environment.

FIG. 4 shows one example wherein the automatic cleaning system 10 is configured to clean a solar panel 6. The jet 5 coupled to the release valve 4 directs the air 44 expelled from the pressure tank 3 over a surface, such as the glass top 42 or other incident surface of a solar panel 6 as shown in FIG. 4. The jet 5 typically includes one or more orifices O₁ . . . O_{N} that direct or shape the air flow of the expelled air 44. Typically, the air flow is directed by the jet 5 to displace particles or otherwise clean the surface over which the air 44 is expelled. The coupling between the release valve 4 and the jet 5 depends on the physical arrangements of the release valve 4 and jet 5 and is typically provided by a series of one or more tubes or guides. In the example shown in FIG. 4, the jet 5 includes a single housing H having a series of orifices O₁ . . . O_{N} that are distributed along an upper edge of the solar panel 6 so that the expelled air 44 sweeps downward in a plane over the surface of the glass top 42 or other incident surface of the solar panel 6. The jet 5 alternatively includes multiple housings H, each with one or more orifices to achieve a variety of designated flow patterns to direct the expelled air 44. Alternative physical arrangements of the jet 5 can be made to accommodate the shape or other attributes of any of a variety of devices, elements, or systems with which the automatic cleaning system 10 is used. While FIG. 4 shows an example wherein the automatic cleaning system 10 according to the first embodiment of the present invention is configured to clean a solar panel 6, each of the automatic cleaning systems 10, 20, 30 is suitable for configuration for use with solar panels, skylights, roofs, greenhouses, or any of a variety of devices, elements or systems to receive expelled air 44 from the automatic cleaning systems 10, 20, 30.

The pressurizer 2 in each of the automatic cleaning systems 10, 20, 30 is configured with the pressure tank 3 to enable the pressurizer 2 to increase the pressure P_{T} of the air 7 contained within the pressure tank 3. In one example, the pressurizer 2 includes a heater that is thermally coupled to the pressure tank 3 and that operates to increase the temperature T of the air 7 contained within the pressure tank 3. When the pressure tank 3 provides a chamber with a volume V for the air 7 contained in the pressure tank 3, increases in the temperature T of the air 7 contained within the pressure tank 3 result in corresponding increases in the internal pressure P_{T} of the pressure tank 3. The internal pressure P_{T} of the pressure tank 3, the temperature T of the air 7 contained within the pressure tank 3, and the volume V of the pressure tank 3 can be expressed according to the well-known relationship, P_{T}=nRT/V, where n represents the number of moles of air contained within the pressure tank 3 and R represents the universal gas constant.

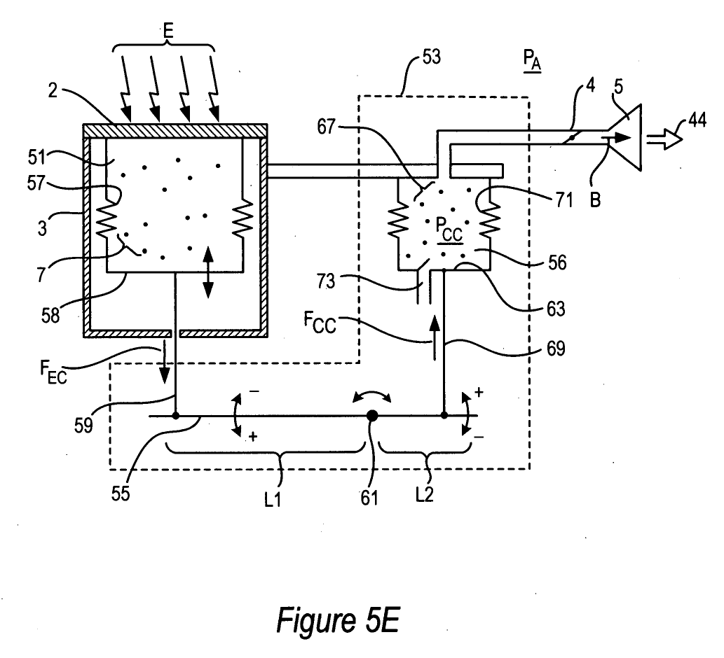

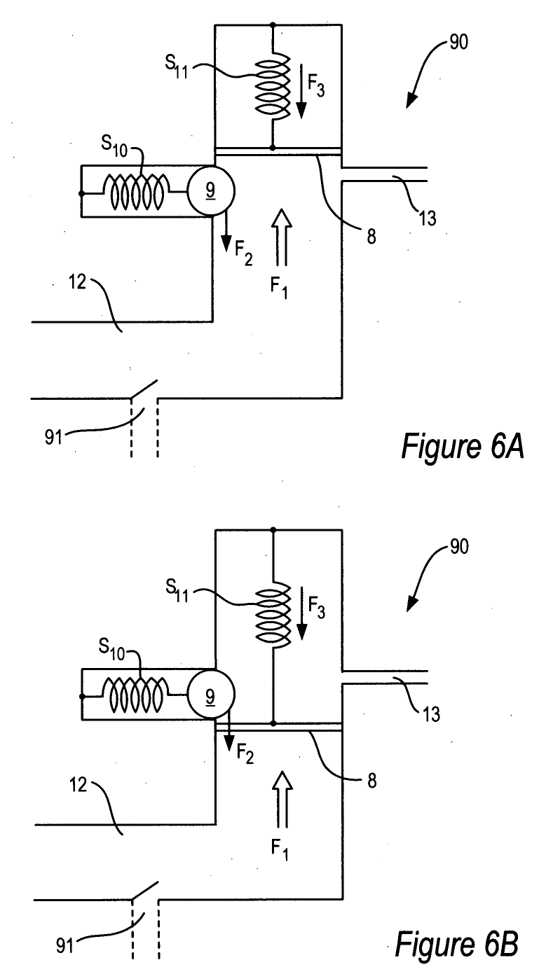

The heater includes any device, element or system suitable for collecting or absorbing solar energy and transferring resulting heat from the collection or absorption of the solar energy to the air contained within the pressure tank 3. In one example shown in FIG. 5A, a heater 50 included in the pressurizer 2 has a dark-colored element 52 that is suitable for absorbing solar energy E provided by the sun and transferring resulting heat from the absorbed solar energy E to the air 7 contained within the pressure tank 3. In this example, the heater 50 includes fins 54 that are exposed to the air 7 within the pressure tank 3 to provide an efficient thermal pathway between the dark-colored element 52 and the air 7. In another example, the heater 50 includes a thermal pathway between the air 7 and the bottom side of a solar panel 6 that includes solar energy collectors, which enables heat to be drawn from the solar energy collectors to the air 7. In alternative examples, the heater 50 includes any type of thermal pathway suitable for transferring heat from the absorbed solar energy E to the air 7. In examples wherein the heater 50 includes a dark-colored element 52, the dark-colored element is an exposed outer surface of the pressure tank 3 that is painted black or another dark color, or the dark-colored element 52 is any other suitable element in sufficient thermal contact with the pressure tank 3 to transfer heat resulting from absorbed solar energy E to the air 7 contained in the pressure tank 3.

In alternative examples shown in FIGS. 5B-5D, the pressurizer 2 includes a greenhouse heater that heats the air 7 contained within the pressure tank 3 using configurations based on the “greenhouse” effect. In FIG. 5B, a greenhouse heater 60 includes a heat chamber 63 having an internal heating element 62, such as a dark-colored element or surface, or other device, element or system suitable for absorbing solar energy E. The solar energy E is absorbed from sunlight that passes through an incident surface 64 of the heat chamber 63. While the incident surface 64 has sufficient optical transparency or other characteristic to enable absorption of solar energy E by the internal heating element 62, the incident surface 64 and the heat chamber 63 provide sufficient thermal insulation from the ambient environment to “trap” resulting heat from the absorption of the solar energy E within the heat chamber 63. This trapped heat can then be transferred to the air 7 contained within the pressure tank 3 through a thermal pathway 66 to increase the temperature of the air 7. In the configuration shown in FIG. 5B, the greenhouse heater 60 has the heat chamber 63 in thermal contact with the air within the pressure tank 3, wherein the heat chamber 63 is distinct from the chamber provided by the pressure tank 3 to contain the air 7. The trapped heat is typically conducted from the heat chamber 63 to the air 7 within the chamber of the pressure tank 3 through the thermal pathway 66. In a second configuration shown in FIG. 5C, the greenhouse heater 70 has a heat chamber 73 that is integrated within the chamber provided by the pressure tank 3 to form a common chamber, designated as element 73. The heating element 72 provided in this example is integrated into the inner walls of the pressure tank 3, or is otherwise included within the common chamber 73 formed within the pressure tank 3. The heating element 72 typically includes a dark-colored element or surface, or other device, element or system suitable for absorbing solar energy E and heating the air 7 contained within the chamber 73. In a third configuration shown in FIG. 5D, the greenhouse heater 80 and pressure tank 3 are integrated into a solar panel. In this configuration, a common chamber 83 is formed between a surface including solar energy collectors 84 of the solar panel, a glass top or other incident surface 82 of the solar panel, and an edge frame 85 of the solar panel. The solar energy collectors 84 of the solar panel provide the heating element that transfers heat from absorbed solar energy E to the air 7 within the chamber 83.

While FIGS. 5B-5D show example configurations of greenhouse heaters 60, 70, 80, any suitable configurations for absorbing solar energy E to heat the air 7 within the pressure tank 3, or chambers 73, 83 are alternatively included as the pressurizer 2 in the automatic cleaning systems 10, 20, 30 according to the embodiments of the present invention. The pressurizer 2 can also include a combustion heater, an electric heater, or any other type of heater suitable for increasing the temperature of the air 7 within the pressure tank 3. Alternatively, the pressurizer 2 includes an air pump coupled to the pressure tank 3 that increases the pressure P_{T} of the air 7 within the pressure tank 3 by pumping more air into the pressure tank 3 or by otherwise compressing the air 7 within the pressure tank 3.

The pressure tank 3 shown in FIGS. 1-3 and FIGS. 5A-5C and the chamber 83 shown in FIG. 5D provide a chamber for containing the air 7. Typically, the pressure tank 3 includes walls that provide thermal insulation from the ambient environment. In the example of the automatic cleaning systems 10, 20, 30, the thermal insulation of the walls of the pressure tank 3 can be made sufficiently high to contain heat that is provided to the air 7 contained within the pressure tank 3 by the pressurizer 2, until air 44 is expelled through the release valve 4 and jet 5. In this example, the pressure tank 3 also has sufficiently low thermal mass so that the air 7 contained within the pressure tank 3 can be heated by the pressurizer 2 in response to absorbed solar energy E, and then cooled in the absence of the solar energy E, for example at night, with a sufficiently low thermal time constant. The thermal insulation and thermal mass of the pressurizer 2, the pressure tank 3, and other elements of the automatic cleaning systems 10, 20, 30 are typically designated to accommodate operating cycles of the automatic cleaning systems 10, 20, 30, which include the pressurizer 2 increasing the pressure P_{T} of the air 7 within the pressure tank 3 and expelling of air provided by the release valve 4 through the jet 5.

The pressure tank 3 can provide a chamber having a fixed volume for the air 7. Alternatively, the pressure tank 3 can include or interface with one or more expansion chambers, compressible bladders, or other devices, elements or systems to control, modulate, or otherwise influence the pressure P_{T} of the air 7 contained within the pressure tank 3. FIG. 5E shows one example wherein the pressure tank 3 includes an expansion chamber 51 to provide a variable volume for the air 7. In this example, the pressure tank 3 is coupled to a pressure amplifier 53 formed by a lever 55 and a compression chamber 56 that also has a variable volume provided by a bellow 71. In response to heating or pressure increases provided to the air 7 by the pressurizer 2, the volume of the expansion chamber 51 increases due to a bellow 57 of the expansion chamber 51. The unfolding of the bellow 57 results in a force F_{EC} on a long arm L1 of the lever 55 that is linked to a moveable portion 58 of the expansion chamber 51 by an input coupling 59. The moveable portion 58 displaces the long arm L1 of the lever 55 so that it rotates about a pivot 61. A short arm L2 of the lever 55 is linked to a moveable portion 63 of the compression chamber 56 through an output coupling 69. Increases in the force F_{EC} provided by the expansion of the air 7 in the expansion chamber 51 are amplified by the lever 55 in a resulting force F_{CC}. The force F_{CC} compresses the air 67 in the compression chamber 56 by acting on the moveable portion 63 to decrease the volume of the compression chamber 56.

The release valve 4 enables air 67 that is contained within the compression chamber 56 to be expelled in the direction of arrow B, once the pressurizer 2 increases the volume of the expansion chamber 51 and once the pressure amplifier 53 transfers the increase in volume into a corresponding pressure increase in the compression chamber 56 through the lever 55. The air 67 contained within the compression chamber 56 is expelled through the release valve 4 in response to a positive differential between the internal pressure P_{CC} of the compression chamber 56 and the ambient pressure P_{A} of the ambient environment. The release valve 4 is typically actuated based on the pressure P_{CC} of the air contained within the compression chamber 56, or according to time, temperature, or other designated parameters or conditions. Alternatively, the release valve 4 is manually actuated. Actuating the release valve 4 provides an open port to expel pressurized air from the compression chamber 56 through the jet 5. Closing the release valve 4 prevents the air 67 contained within the compression chamber from flowing out of the compression chamber 56. Preventing air 67 from flowing out of the compression chamber 56 enables the pressurizer 2 to increase the pressure P_{T} of the air 7 contained within the pressure tank 3, which enables the pressure amplifier 53 to increase the pressure of the air 67 contained within the compression chamber 56, until the air is expelled from the compression chamber 56 in the direction B through the release valve 4 and through the jet 5. A check valve 73 can be included in the compression chamber 56 to enable air to be drawn into the compression chamber 56 in response to a negative differential between the pressure P_{CC} of the air 67 within the compression chamber 56 and the ambient pressure P_{A} of the ambient environment. Alternatively, the release valve 4 can provide an open port to enable air to be drawn into the compression chamber 56 in response to a negative differential between the pressure P_{CC} and the ambient pressure P_{A}.

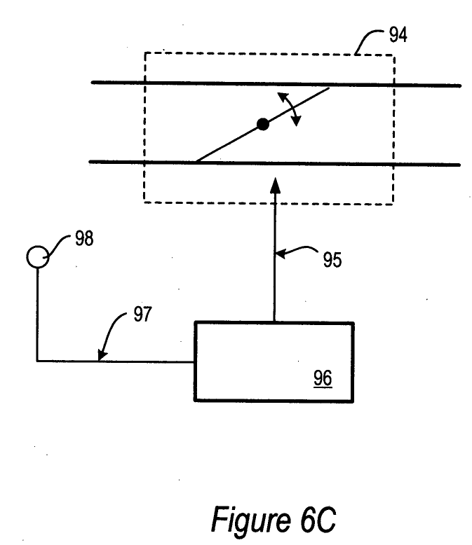

In each of the automatic cleaning systems 10, 20, 30, expelled air 44 is provided by the release valve 4 and through the jet 5. Air 44 is expelled based on a positive differential between the internal pressure P_{T} of the pressure tank 3 and an ambient pressure P_{A}, even though the pressure P_{T} of the pressure tank 3 may be amplified by a pressure amplifier 22 and/or stored by a storage tank 36. In one example shown in FIGS. 6A-6B, the release valve 4 is implemented with a self-actuated valve 90 that is actuated according to the pressure of the air that is exposed to the release valve 4, as implemented with the self-actuated valve 90. In the automatic cleaning system 10 shown in FIG. 1, the release valve 4, as implemented with the self-actuated valve 90, is exposed to the pressure P_{T} of the air 7 contained within the pressure tank 3. In the automatic cleaning system 20 shown in FIG. 2, the release valve 4, as implemented with the self-actuated valve 90, is exposed to the pressure P_{OC} of the air 28 within the output cylinder 26 of the pressure amplifier 22. In the automatic cleaning system shown in FIG. 3, the release valve 4, as implemented with the self-actuated valve 90, is exposed to the pressure P_{S} of the air 37 within the storage tank 36.

For the purpose of illustrating operation of the self-actuated valve 90 shown in FIGS. 6A-6B, the self-actuated valve 90 is described in the context of the automatic cleaning system 10 shown in FIG. 1, wherein the self-actuated valve 90 is exposed to the pressure P_{T} of the air 7 contained within the pressure tank 3. In this example, the self-actuated valve 90 has an inlet 12 that is coupled to the air 7 within the pressure tank 3 and an outlet 13 that is coupled to the jet 5. FIG. 6A shows the self-actuated valve 90 in the open state, whereas FIG. 6B shows the self-actuated valve 90 in the closed state. The open state enables the air 7 contained within the pressure tank 3 to be expelled through the jet 5. The open state results from the air 7 contained within the pressure tank 3 reaching a first threshold pressure, which causes a force F₁ provided to a pressure plate 8 by the pressure P_{T} of the air 7 contained within the pressure tank 3 to exceed the sum of a force F₂ and a force F₃ that also act on the pressure plate 8. The force F₂ is provided by a spring S₁₀, as translated through a ball 9 or other suitably shaped surface. The force F₃ is provided by a spring S₁₁.

The closed state of the self-actuated valve 90, as shown in FIG. 6B, results from the air 7 contained within the pressure tank 3 reaching a second threshold pressure that is less than the first threshold pressure. The difference between the first threshold pressure that opens the self-actuated valve 90 and the second threshold pressure that closes the self-actuated valve 90 provides hysteresis to the switching of the self-actuated valve 90, which can stabilize operation of the self-actuated valve 90 by preventing multiple transitions, or toggling, between the closed state and the open state that could result if the air 7 contained within the pressure tank 3 were to fluctuate about a single designated threshold pressure. The closed state of the self-actuated valve 90 prevents coupling between the inlet 12 and the outlet 13 so that the air 7 contained within the pressure tank 3 coupled to the inlet 12 is not exchanged with ambient air. The self-actuated valve 90 is in the closed state when a force F₁ provided to the pressure plate 8 by the air 7 contained within the pressure tank 3 is less than the sum of the force F₂ and the force F₃ that act on the pressure plate 8. When the release valve 4 in the automatic cleaning system 10 is implemented with the self-actuated valve 90, the intake valve 1 enables air to be drawn into the pressure tank 3 in response to a negative differential between the internal pressure P_{T} of the pressure tank 3 and the ambient pressure P_{A} of the ambient environment. When the release valve 4 in the automatic cleaning system 20 is implemented with the self-actuated valve 90, an optionally included check valve 91 (shown in FIGS. 6A-6B as a dashed element 91) enables air to be drawn into the output cylinder 26 in response to a negative differential between the internal pressure P_{OC} of the output cylinder 26 and the ambient pressure P_{A} of the ambient environment. When the release valve 4 in the automatic cleaning system 30 is implemented with the self-actuated valve 90, the input check valve 32 and the output check valve 34 enable air to be drawn into the storage tank 36 in response to a negative differential between the internal pressure P_{S} of the storage tank 36 and the ambient pressure P_{A} of the ambient environment. Alternative types of self-actuated valves include thermostats that are thermally activated, for example, based on the temperature of the air exposed to the self-actuated valves.

In an alternative example shown in FIG. 6C, the release valve 4 is implemented with a switch valve 94 actuated according to a control signal 95 that is provided by a controller 96, which opens and closes the switch valve 94. An input signal 97 is provided by a sensor 98 to the controller 96. In one example, the sensor 98 includes a temperature sensor or a pressure sensor that can be positioned within the pressure tank 3, the pressure amplifier 22, the storage tank 36 or in any other suitable location within the automatic cleaning systems 10, 20, 30 to enable the controller 96 to establish the opening or closing of the switch valve 94.

In an alternative example, the sensor 98 includes a current or voltage sensor coupled to a solar panel 6 so that the controller 96 can generate a control signal 95 to open or close the switch valve 94 based on the output conditions of the solar panel 6. For example, a current sensor coupled to the solar panel 6 can provide an input signal 97 to the controller 96 that enables the controller 96 to provide a control signal 95 to open the switch valve 94 to expel air 44 over the solar panel 6 under high output current conditions of the solar panel 6. The high current conditions in this example indicate that a correspondingly high level of solar energy E is incident on the pressurizer 2. The controller 96 can alternatively provide a control signal 95 to open the switch valve 94 at a designated time delay from high output current conditions sensed by the current sensor. This enables the air 44 expelled through the jet 5 to occur at a time other than when a high level of solar energy E is incident on the pressurizer 2. For example, there may be an advantage to expel the air 44 through the jet 5 before dawn in environments where there is dew-fall or morning condensation on the solar panels 6. Expelling the air before dawn may reduce moistening of particles that land on the glass top 42 or other incident surface of the solar panel 6 by condensation or dew, and later baking of the moistened particles by incident solar energy E, which could make otherwise light-weight particles difficult to remove by the expelled air 44.

In an alternative example, the sensor 98 includes a moisture sensor, or a series of differential temperature sensors suitable for determining the occurrence of dew, condensation or other moisture, to enable the controller 96 to generate a control signal 95 to open or close the switch valve 94 in response to, or in anticipation of, dew, condensation, or other moisture.

The controller 96 can also be used in the absence of a sensor 98 and input signal 97, providing instead a control signal 95 to open or close the switch valve 94 at designated times or designated time intervals. The automatic cleaning system 30, which includes the storage tank 36 is well-suited for applications wherein the air 44 is expelled in the absence of incident solar energy E on the pressurizer 2.

The automatic cleaning systems 10, 20, 30 can be used instead of, or in conjunction with, manual cleaning or alternative cleaning of solar panels, skylights, roofs, greenhouses, or any of a variety of devices, elements or systems that receive expelled air 44 from the automatic cleaning systems 10, 20, 30. The automatic cleaning systems 10, 20, 30 can be used to supplement manual cleaning or to reduce the frequency of manual cleaning.

In each of the examples of the automatic cleaning systems 10, 20, 30 shown in FIGS. 1-3, the intake valve 1 is shown as a single valve. In alternative embodiments of the present invention, the intake valve 1 includes a series of one or more separate intake valves. In alternative embodiments of the present invention, the release valve 4 includes a series of one or more release valves to provide the air 44 expelled from the jet 5. In alternative embodiments of the present invention, the release valve 4 and the intake valve 1 are integrated into a switch valve that serves both of the functions of the intake valve 1 and the release valve 4. In alternative examples of the automatic cleaning systems 20, 30, the intake valve 1 is omitted from the pressure tank 3 to provide a sealed chamber for the air 7 within the pressure tank 3, wherein the air 7 is defined to include any gas suitable to be contained within the pressure tank 3. In these examples, the internal pressure P_{T} of the pressure tank 3 increases in response to the heating provided by the pressurizer 2 and decreases in response to the absence of heating by the pressurizer 2. In alternative examples of the automatic cleaning systems 10, 20, 30, the intake valve 1 is implemented with a check valve, pressure actuated valve, temperature actuated valve or other type of self-actuated valve. Alternatively, the intake valve 1 is actuated by a control signal to accommodate operating cycles of the automatic cleaning system 10, 20, 30.

The pressure amplifier 22 can also include one or more check valves that draw air into various elements of the automatic cleaning systems 20, 30, as needed to accommodate the operating cycles of the automatic cleaning systems 20, 30. The pressure amplifier 22 can also include springs or other devices, elements, or systems to provide restoring forces or other bias to bladders, pistons or other elements of pressure amplifier 22 to accommodate the operating cycles of the automatic cleaning systems 20, 30. According to alternative embodiments of the present invention, the pressure amplifier 22 is implemented with any device, element or system that achieves an amplification of increases in the pressure P_{T} of the air 7 within the pressure tank 3.

While FIG. 4 shows the elements of an automatic cleaning system configured with a single solar panel 6, according to alternative embodiments of the present invention, the elements of the automatic cleaning system are distributed among one or more solar panels, or the elements are physically dispersed, or elements of the automatic cleaning systems, other than the jet 5, are located physically separate, or remote from the solar panel 6, or other device, element, or system with which the automatic cleaning system 10, 20, 30 is configured.

While the embodiments of the present invention have been illustrated in detail, it should be apparent that modifications and adaptations to this embodiment may occur to one skilled in the art without departing from the scope of the present invention as set forth in the following claims.

1. An automatic cleaning system, comprising:
a pressure tank;
a pressurizer, thermally coupled to the pressure tank, that increases the internal pressure of the pressure tank based on transferring heat from absorbed solar energy to air within the pressure tank;
a release valve coupled to a jet that directs expelled air based on a positive differential between the internal pressure of the pressure tank and an ambient pressure of an ambient environment.

2. The automatic cleaning system of claim 1 wherein the pressurizer includes a greenhouse heater.

3. The automatic cleaning system of claim 2 wherein the greenhouse heater is integrated into the pressure tank, and wherein the greenhouse heater and the pressure tank share a common chamber.

4. The automatic cleaning system of claim 3 wherein the greenhouse heater and pressure tank are integrated into a solar panel, and wherein the common chamber is provided between a surface that includes solar energy collectors of the solar panel, an incident surface of the solar panel, and an edge frame of the solar panel.

5. The automatic cleaning system of claim 1 wherein the pressure tank, the pressurizer, the release valve, and the jet are configured with a solar panel, and wherein the jet directs the expelled air over an incident surface of the solar panel.

6. The automatic cleaning system of claim 1 wherein the expelled air directed by the jet results from actuating the release valve in response to a control signal based on at least one of a sensed temperature, a sensed pressure, a sensed dew, and a time.

7. The automatic cleaning system of claim 1 wherein the expelled air directed by the jet is provided in response to at least one of a pressure and a temperature of air exposed to the release valve.

8. The automatic cleaning system of claim 1 further comprising a pressure amplifier interposed between the pressure tank and the release valve, wherein the pressure amplifier provides the expelled air.

9. The automatic cleaning system of claim 8 wherein the pressurizer includes a greenhouse heater.

10. The automatic cleaning system of claim 9 wherein the greenhouse heater is integrated into the pressure tank, and wherein the greenhouse heater and the pressure tank share a common chamber.

11. The automatic cleaning system of claim 10 wherein the greenhouse heater and pressure tank are integrated into a solar panel, and wherein the common chamber is provided between a surface that includes solar energy collectors of the solar panel, an incident surface of the solar panel, and an edge frame of the solar panel.

12. The automatic cleaning system of claim 8 wherein the pressure tank, the pressurizer, the pressure amplifier, the release valve, and the jet are configured with a solar panel, and wherein the jet directs the expelled air over an incident surface of the solar panel.

13. The automatic cleaning system of claim 8 wherein the expelled air directed by the jet results from actuating the release valve in response to a control signal based on at least one of a sensed temperature, a sensed pressure, a sensed dew, and a time.

14. The automatic cleaning system of claim 8 wherein the expelled air directed by the jet is provided in response to at least one of a pressure and a temperature of air exposed to the release valve.

15. The automatic cleaning system of claim 1 further comprising a pressure amplifier and a storage tank interposed between the pressure tank and the release valve, wherein the pressure amplifier compresses air within the storage tank, and wherein the storage tank provides the expelled air.

16. The automatic cleaning system of claim 15 wherein the pressurizer includes a greenhouse heater.

17. The automatic cleaning system of claim 16 wherein the greenhouse heater is integrated into the pressure tank, and wherein the greenhouse heater and the pressure tank share a common chamber.

18. The automatic cleaning system of claim 17 wherein the greenhouse heater and pressure tank are integrated into a solar panel, and wherein the common chamber is provided between a surface that includes solar energy collectors of the solar panel, an incident surface of the solar panel, and an edge frame of the solar panel.

19. The automatic cleaning system of claim 15 wherein the expelled air directed by the jet results from actuating the release valve in response to a control signal based on at least one of a sensed temperature a sensed pressure, a sensed dew, and a time.

20. The automatic cleaning system of claim 15 wherein the expelled air directed by the jet is provided in response to at least one of a pressure and a temperature of air exposed to the release valve.
